(19) United States
(12) Patent Application Publication
(10) Pub. No.: US 2012/0314078 A1
(43) Pub. Date: Dec. 13, 2012

(54) OBJECT MONITORING APPARATUS AND METHOD THEREOF, CAMERA APPARATUS AND MONITORING SYSTEM

(75) Inventors: Liang LI, Beijing (CN); Weiguo Wu, Beijing (CN)

(73) Assignee: Sony Corporation, Tokyo (JP)

(21) Appl. No.: 13/477,378

(22) Filed: May 22, 2012

(30) Foreign Application Priority Data
Jun. 13, 2011 (CN) 201110166823.8

(51) Int. Cl. H04N 7/18; G06K 9/62

(52) U.S. Cl. 348/159; 382/103; 348/E07.085

(57) ABSTRACT

A method of monitoring an object in images captured by N camera apparatuses including: for an i^{th} camera apparatus among the N camera apparatuses, obtaining respective first matching similarities of a specific object in an image captured by the i^{th} camera apparatus with respect to one or more objects in an image captured by a j^{th} camera apparatus respectively according to a pre-constructed feature conversion model between the camera apparatuses; and determining an object matching with the specific object in the image captured by the j^{th} camera apparatus based on the respective first matching similarities to thereby monitor the specific object. There is further disclosed a method of performing an interactive operation of a related monitored object by using the foregoing monitoring method.

### FIELD OF THE INVENTION

The present invention generally relates to the field of image processing and in particular to a method and apparatus for monitoring an object in an image captured by a camera apparatus and a monitoring system.

### BACKGROUND OF THE INVENTION

Video monitoring systems currently have been widely applied in various public places (e.g., a hotel, a shopping mall, a bus or railway station, an airport, etc.) and private places (e.g., a factory, an office building, etc.) and also have been scaled up rapidly along with an increasing monitored scope. A large monitoring system generally tends to manage hundreds and even thousands of monitoring devices (e.g., monitoring camera apparatuses). Since the existing monitoring devices can not display real time data of all the monitoring devices at the same time, the majority of monitoring systems have respective monitored pictures displayed in turn or as needed. Therefore, when there is an alarm event occurring with a specific monitoring device, the systems can only operate at the background and consequently fail to forecast or immediately process a monitored event. Furthermore, the existing monitoring systems generally display the monitored pictures of the respective monitoring devices separately, and a user can not know globally the condition of a monitoring context and more easily gets fatigued or degrades his attention. On the other hand, the existing monitoring systems can not provide global information of a specific monitored object in the monitoring context. For example, when an abnormal event occurs, it is generally necessary to know information of a related suspicious person traveling and staying among different camera apparatuses in the monitoring context to thereby assisting a surveillant in retrieving related information more rapidly.

A method and system for integrating and displaying multiple videos during monitoring are proposed in the Chinese Patent Application No. 200710064819.4, entitled “Method and system for integrating and displaying information of multiple videos during monitoring” to display multiple videos in a virtual electronic map, but this solution lacks a linked-monitoring function of multiple monitoring cameras in that the respective monitoring terminals monitor separately from each other.

### SUMMARY OF THE INVENTION

In view of the circumstance in the prior art, embodiments of the invention provide an object monitoring solution across monitoring cameras.

Particularly there is provided according to an embodiment of the invention a monitoring method which includes: performing, for an i^{th} camera apparatus among N camera apparatuses, the operations of: performing feature conversion between a feature of an object in an image captured by the i^{th} camera apparatus and a feature of an object in an image captured by a j^{th} camera apparatus among the N camera apparatuses according to a pre-constructed feature conversion model between the camera apparatuses, and obtaining respective first matching similarities of a specific object in the image captured by the i^{th} camera apparatus respectively with respect to one or more objects in the image captured by the j^{th} camera apparatus based on the result of feature conversion, wherein N is an integer above or of 2, i is an integer greater than or equal to 1 and less than or equal to N, j=1, 2, . . . , N, j is an integer, and determining an object matching with the specific object in the image captured by the j^{th} camera apparatus based on the respective first matching similarities to thereby monitor the specific object.

Another embodiment of the invention further provides a monitoring device which includes: a similarity determining unit configured to, for an i^{th} camera apparatus among N camera apparatuses, perform feature conversion between a feature of an object in an image captured by a i^{th} camera apparatus and a feature of an object in an image captured by the j^{th} camera apparatus among the N camera apparatuses according to a pre-constructed feature conversion model between the camera apparatuses, and obtain respective first matching similarities of a specific object in the image captured by the i^{th} camera apparatus respectively with respect to one or more objects in the image captured by the j^{th} camera apparatus based on the result of feature conversion, wherein N is an integer greater than or equal to 2, i is an integer greater than or equal to 1 and less than or equal to N, j=1, 2, . . . , N, j is an integer, and i≠j; and a monitoring unit configured to determine an object matching with the specific object in the image captured by the j^{th} camera apparatus based on the respective first matching similarities to thereby monitor the specific object.

Still another embodiment of the invention further provides a camera apparatus including the foregoing monitoring device according to the embodiment of the invention.

Another embodiment of the invention further provides an operating method in a monitoring system, which includes: monitoring an object in a monitoring system in the foregoing object monitoring method according to the embodiment of the invention, wherein the monitoring system includes the N camera apparatuses; and performing an interactive operation for the object monitored by the monitoring system based on the monitoring result.

Another embodiment of the invention further provides a monitoring system which comprises: N camera apparatuses; a monitoring device which comprises: a similarity determining unit configured to, for an ith camera apparatus among the N camera apparatuses, perform feature conversion between a feature of an object in an image captured by the ith camera apparatus and a feature of an object in an image captured by a jth camera apparatus among the N camera apparatuses according to a pre-constructed feature conversion model between the camera apparatuses, and obtain respective first matching similarities of a specific object in the image captured by the ith camera apparatus respectively with respect to one or more objects in the image captured by the jth camera apparatus based on the result of feature conversion, wherein N is an integer greater than or equal to 2, i is an integer greater than or equal to 1 and less than or equal to N, j=1, 2, . . . , N, j is an integer, and i≠j; and a monitoring unit configured to determine an object matching with the specific object in the image captured by the jth camera apparatus based on the respective first matching similarities to thereby monitor the specific object; and an interface configured to receive an operation instruction and output monitoring information.

According to another embodiment of the invention, there is further provided a program product on which machine readable instruction codes are stored, wherein the instruction codes upon being read and executed by a machine can make the machine perform the foregoing method for monitoring an object in images captured by N camera apparatuses.

According to another embodiment of the invention, there is further provided a storage medium on which machine readable instruction codes are embodied, wherein the instruction codes upon being read and executed by a machine can make the machine perform the foregoing method for monitoring an object in images captured by N camera apparatuses.

According to another embodiment of the invention, there is further provided an object matching method, the method comprising: performing feature conversion between a feature of a first object in a first image and a feature of one or more second objects in a 35 second image according to a pre-constructed feature conversion model, and obtaining respective first matching similarities of the first object respectively with respect to the second objects in the second image based on the result of feature conversion; and determining a second object matching with the first object based on the respective first matching similarities.

According to another embodiment of the invention, there is further provided a program product on which machine readable instruction codes are stored, wherein the instruction codes upon being read and executed by a machine can make the machine perform the foregoing object matching method.

According to another embodiment of the invention, there is further provided a storage medium on which machine readable instruction codes are embodied, wherein the instruction codes upon being read and executed by a machine can make the machine perform the foregoing object matching method.

As can be apparent from the above description, the monitoring solution according to the invention can perform an object tracking function across camera apparatuses in a monitoring context. Furthermore, real time displaying and interaction of monitoring information in the monitoring context can be performed in a virtual electronic map, real time displaying of a global route of a monitored object in the monitoring context can be performed in the virtual electronic map, and also a function of retrieving a global route of a specific monitored object in a history monitoring video can be provided.

### BRIEF DESCRIPTION OF THE DRAWINGS

The foregoing and other objects, features and advantages of the invention will become apparent from the following description of respective embodiments of the invention with reference to the drawings throughout which identical or like reference numerals denote identical or like functional components or steps. In the drawings:

FIG. 1 is a simplified flow chart of a method for monitoring an object in images captured by N camera apparatuses according to an embodiment of the invention;

FIG. 2a to FIG. 2c are schematic diagrams of a color conversion model used in the method for monitoring an object in images captured by N camera apparatuses according to the embodiment of the invention;

FIG. 3 is a schematic diagram of a temporal/spatial conversion probability distribution used in the method for monitoring an object in images captured by N camera apparatuses according to the embodiment of the invention;

FIG. 4 is a simplified flow chart of a specific implementation of the method shown in FIG. 1;

FIG. 5a illustrates a structural block diagram of an illustrative configuration of a device for monitoring an object in images captured by N camera apparatuses according to an embodiment of the invention;

FIG. 5b illustrates a structural block diagram of an illustrative configuration of an alternative solution of the object monitoring device illustrated in FIG. 5a;

FIG. 6 is a simplified structural block diagram of a specific implementation of a similarity determining unit illustrated in FIG. 5;

FIG. 7 is a simplified structural block diagram of a color conversion model constructing unit further included in an alternative implementation of the device illustrated in FIG. 5;

FIG. 8 is a simplified structural block diagram of a specific implementation of a color value difference determining sub-unit illustrated in FIG. 6;

FIG. 9 is a simplified structural block diagram of a specific implementation of a temporal/spatial conversion probability distribution determining unit illustrated in FIG. 5;

FIG. 10 is a simplified structural block diagram of a specific implementation of the device illustrated in FIG. 5b;

FIG. 11 is a simplified flow chart of an operating method in a monitoring system according to an embodiment of the invention;

FIG. 12 is a schematic diagram of a specific scenario implemented in the operating method illustrated in FIG. 11;

FIG. 13 is a schematic diagram of another specific scenario implemented in the operating method illustrated in FIG. 11;

FIG. 14 is a schematic diagram of a further specific scenario implemented in the operating method illustrated in FIG. 11; and

FIG. 15 is an illustrative structural block diagram of a personal computer as the monitoring device can be used in the respective embodiments of the invention.

### DETAILED DESCRIPTION OF THE INVENTION

Embodiments of the present invention will be described below with reference to the accompanying drawings. It shall be noted that only those device structures and/or process steps closely relevant to the implementation solution of the invention will be illustrated in the drawings while other details less relevant to the invention are omitted so as not to obscure the invention due to those unnecessary details. Identical or like constituent elements or parts will be denoted with identical or like reference numerals throughout the drawings.

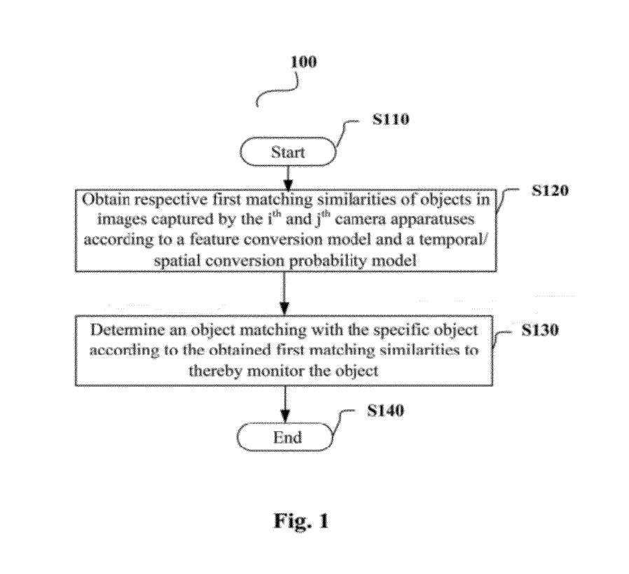

FIG. 1 is a simplified flow chart of a method for monitoring an object in images captured by N camera apparatuses according to an embodiment of the invention. As illustrated in FIG. 1, the method 100 starts with S110. At S120, the following operations are performed for the i^{th} camera apparatus among the N camera apparatuses: feature conversion is performed between a feature of an object in an image captured by the i^{th} camera apparatus and a feature of an object in an image captured by the j^{th} camera apparatus according to a pre-constructed feature conversion model between the camera apparatuses, and respective first matching similarities of a specific object in the image captured by the i^{th} camera apparatus respectively with respect to one or more objects in the image captured by the j^{th} camera apparatus are obtained based on the result of feature conversion. Here N is an integer greater than or equal to 2, i is an integer greater than or equal to 1 and less than or equal to N, j=1, 2, . . . , N, j is an integer, and i≠j. At S130, an object matching with the specific object in the image captured by the j^{th} camera apparatus is determined based on the respective first matching similarities to thereby monitor the specific object.

In the object monitoring method according to the present embodiment, the i^{th} camera apparatus among the N camera apparatuses can be selected arbitrarily and then matched in similarity respectively against the other camera apparatuses, i.e., the i^{th} camera apparatus (j=1, 2, . . . , N and i≠j) in terms of an object feature. It can be determined which object in the image captured by the j^{th} camera apparatus is matched with a specific object in the image captured by the i^{th} camera apparatus according to the matching result. Here the specific object in the image captured by the i^{th} camera apparatus refers to a predetermined object which needs to be monitored. As can be apparent, this specific object may include one or more objects. The foregoing monitoring process can be performed respectively for all the objects present in the image captured by the i^{th} camera apparatus if this is allowed by the processing capacity and load of a system. Furthermore, the object monitoring process can alternatively be performed in a part of all the N camera apparatuses in the monitoring system as needed. In this case, the i^{th} camera apparatus and the j^{th} camera apparatus in the present embodiment can simply be selected from this part of the camera apparatuses. Furthermore, when there is more than one object to be monitored, the foregoing matching process can be performed for each object to thereby monitor all the objects.

Regarding a criterion to determine whether an object matching with the foregoing specific object is found, the criterion can be set, for example, that if an obtained first matching similarity is greater or equal to a preset threshold, then it indicates that an object corresponding to the first matching similarity in the image captured by the j^{th} camera apparatus matches with the specific object, that is, the object belongs to a monitored object. The threshold can be set under a practical condition. For example, the threshold can be obtained experimentally or empirically, and a detailed description thereof will be omitted here.

Furthermore, the foregoing object feature similarity matching process can be performed respectively between the specific object in the image captured by the i^{th} camera apparatus and all the objects in the image captured by the j^{th} camera apparatus or between the specific object and only a part of all the objects in the image captured by the j^{th} camera apparatus. For example, in the event that those objects apparently mismatching with the foregoing specific object among all the objects in the image captured by the j^{th} camera apparatus can be filtered out by anther other process, the foregoing object feature similarity matching process can be performed only for the objects that remain after filtering-out to thereby finally obtain a object matching with the specific object.

When the monitoring method according to the present embodiment is performed, for example, a first frame of image captured by the i^{th} camera apparatus can firstly be matched against an object in a first frame of image captured by each of the other camera apparatuses. Typically a specific object in the first frame of image captured by the i^{th} camera apparatus is selected as an object to be monitored as needed, and after an object in the image captured by the other camera apparatus matching with the specific object in the first frame of image captured by the i^{th} camera apparatus is found, the specific object can be monitored in the respective camera apparatuses through a frame tracking process in the respective camera apparatuses (this process is a function inherent to the respective camera apparatuses) without performing a further similar matching process for any other frame of image. Of course, if tracking information is absent or lost in any camera apparatus, then the foregoing matching process can be performed for each frame of image captured by the i^{th} camera apparatus to thereby monitor the specific object.

In an alternative solution of the foregoing embodiment, respective temporal/spatial conversion probability distributions of the specific object in the image captured by the i^{th} camera apparatus and the one or more objects in the image captured by the j^{th} camera apparatus between the positions of the i^{th} camera apparatus and the j^{th} camera apparatus can further be obtained respectively according to a temporal/spatial conversion probability model between the camera apparatuses, in addition to the first matching similarities between the objects in the images captured by the i^{th} camera apparatus and the j^{th} camera apparatus. Correspondingly, an object matching with the specific object in the image captured by the j^{th} camera apparatus can be subsequently determined based on both the obtained respective first matching similarities and respective temporal/spatial conversion probability distributions to thereby monitor the specific object.

Similarly, the foregoing process of obtaining respective temporal/spatial conversion probability distributions can be performed respectively between the specific object in the image captured by the i^{th} camera apparatus and all the objects in the image captured by the j^{th} camera apparatus. However, for example, in the event that those objects apparently mismatching with the specific object among all the objects in the image captured by the j^{th} camera apparatus can be filtered out by another process, this process of obtaining respective temporal/spatial conversion probability distributions can be performed between the specific object and only the objects that remain after filtering-out in the image captured by the j^{th} camera apparatus.

When a specific object is monitored in a monitoring system including a plurality of camera apparatuses using images captured by the respective camera apparatuses, it is generally necessary to find the same monitored object in the images captured by the different camera apparatuses. The same monitored object can be determined by searching the images captured by the respective camera apparatuses for a specific object with a high matching similarity. As can be apparent, the captured images of even the same object may differ from each other due to configuration parameters of the respective camera apparatuses, a characteristic dispersion of constituent components thereof and other reasons. In view of this, the matching similarity between the objects captured by the camera apparatuses is determined using the feature conversion model to take into account this difference in terms of a feature in the method according to the foregoing embodiment of the invention. In a specific implementation, this feature conversion model can be a color conversion model, for example. The color conversion model can represent a correspondence relationship between color values of the objects in the images captured by the different camera apparatuses. Furthermore, a color value conversion process can be performed by using the color conversion model to obtain the difference between the color values of the objects, and the first matching similarly between the specific object captured by the i^{th} camera apparatus and each object in the image captured by the j^{th} camera apparatus in terms of a color value can be determined from this difference.

As described above, in an alternative embodiment of the invention, a temporal/spatial conversion probability distribution condition of an object appearing in the respective camera apparatuses can also taken into account in addition to the difference between the objects in the images captured by the different camera apparatuses in term of a feature value. This temporal/spatial conversion probability distribution condition can be obtained in a temporal/spatial conversion probability model which describes a probability model of a period of time spent for a monitored object to travel at a normal speed from the place where one monitoring camera apparatus is located to the place where another monitoring camera apparatus is located in a practical monitoring context. Here the so-called “normal speed” refers to a typical speed at which an object of the same category travels in the monitoring context, which can be obtained experimentally or empirically.

In a specific implementation, this temporal/spatial conversion probability distribution can be determined from a typical traveling speed of an object of the same category as the specific object between the respective camera apparatuses and the positional relationship between the camera apparatuses. Typically this temporal/spatial conversion probability distribution appears as a normal distribution. This will be described below in details.

It shall be noted that the process of obtaining the first matching similarities between the objects in the video images captured by the camera apparatus and the j^{th} camera apparatus and the process of obtaining the temporal/spatial conversion probability distribution between the positions of the i^{th} camera apparatus and the j^{th} camera apparatus as mentioned in the foregoing embodiment are performed sequentially but not necessarily in any required order. As can be apparent, if the first matching similarities are firstly obtained, then a part of the objects impossible to match with the specific object can be filtered out according to the feature conversion relationship, and next the surviving objects can be further processed by using the temporal/spatial conversion probability model to thereby obtain a object matching the best with the specific object finally. If the temporal/spatial conversion probability related process is firstly performed, then a part of the objects impossible to match with the specific object can also be filtered out, and next the first matching similarities can be obtained for the surviving objects by using the feature conversion model to thereby obtain a object matching the best with the specific object finally. As can be seen from the above, the results of matching the object in term of both the feature conversion and a temporal/spatial conversion probability are taken into account in either of the processing modes.

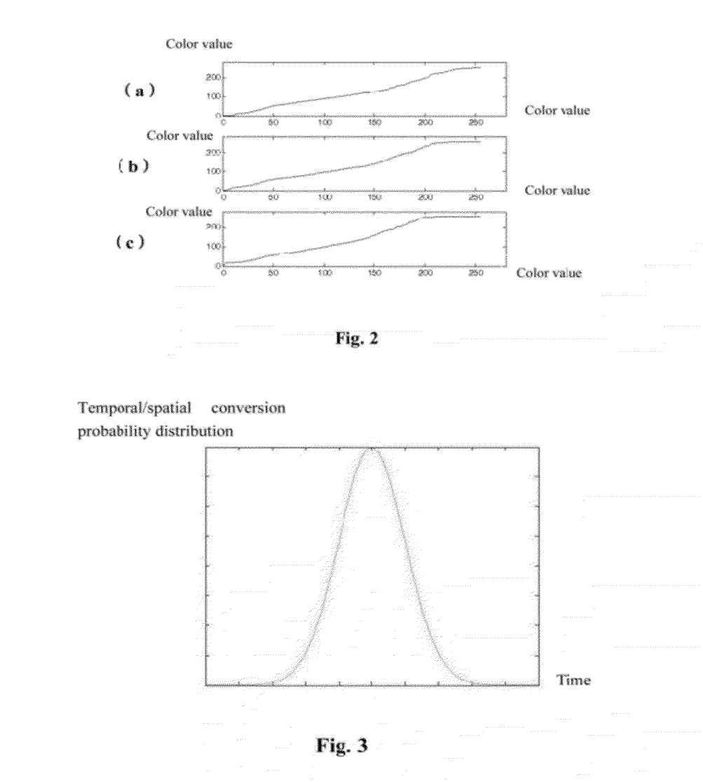

A specific example of the process of obtaining the first matching similarities will be described below with reference to FIG. 2.

Firstly an example of constructing a color conversion model will be described.

Assuming the monitoring camera apparatuses in a practical monitoring scenario are numbered CAMⁱ, i ε {1, 2, . . . , N}, where N represents the number of camera apparatuses, and color conversion models of objects in the images captured by the i^{th} camera apparatus CAMⁱ and the j^{th} camera apparatus CAM^{j} will be determined. A predetermined number of images captured by each of the camera apparatuses CAMⁱ and CAM^{j} are selected as a training set of images. In this example, the predetermined number is 1000, for example. For example, the color conversion model is constructed in the RGB color space. Color histograms R_Hⁱ(x), G_Hⁱ(x), B_Hⁱ(x) of three color channels of the respective images in the training set of images of the camera apparatus CAMⁱ are calculated, where values of the color histogram are in the range of [0, 255]. Similarly, color histograms R_H^{j}(x), G_H^{j}(x), B_H^{j}(x) of three color channels of the respective images in the training set of images of the camera apparatus CAM^{j} are calculated, where values of the color histogram are in the range of [0, 255]. The color histogram is a common concept in the art to describe the proportions of different colors throughout an image without considering the spatial position of each color. Values in the color histogram are obtained statistically to describe a quantitative feature of the colors in the image and to reflect a statistical distribution and a fundamental hue of the colors of the image in the color histogram. For more information on the color histogram, reference can be made to “Computer Vision” by Shapiro, Linda G and Stockman, George C. (Prentice Hall, 2003 ISBN 0130307963) and “Color Histogram” at http://en.wikipedia.org/wiki/Color_histogram.

Next a conversion relationship or a mapping relationship of color values between the camera apparatuses CAMⁱ and CAM^{j} is constructed from the obtained color histograms. Here taking the histogram of the R channel as an example, index values are extracted sequentially from R_Hⁱ according to the range of color values, R_H^{j} is searched respectively for the color values closest to the index values, and a color conversion curve is constructed according to the found corresponding color values, that is, the color conversion model cft^{i,j} of the R channel of the camera apparatus CAMⁱ and the camera apparatus CAM^{j} can be represented in the formula (I) of:

cft^{i,j}(R_{—}Hⁱ(x))=R_{—}H^{j}^{^{−1}}(R_{—}Hⁱ(x)),xε[0,255] (formula 1)

The parameter x in the formula represents an index value in the color histogram, i.e., a color value in the color histogram. Although the different camera apparatuses may capture the same object somewhat differently as a whole, e.g., in a brighter or darker hue, etc., due to different configuration parameters, the color histograms, i.e., color distribution conditions, of the captured images shall be identical. Thus the index value x in the color histogram of the image captured by the camera apparatus CAMⁱ on the left side of the foregoing formula (I) corresponds to a proportion value R_Hⁱ(x), i.e., the proportion of a color value represented by the index value x throughout the image. The proportion value R_Hⁱ(x) is substituted into the inverse function R_H^{j}^{^{−1}} of the color histogram of the camera apparatus CAM^{j} on the right side of the formula (I) to obtain the color value corresponding to the proportion value in the color histogram of the image captured by the camera apparatus CAM^{j}. Thus color values in the image captured by the camera apparatus CAM^{j} which are the closest to respective color values in the image captured by the camera apparatus CAMⁱ can be found. Color value conversion relationships of the G channel and the B channel of the camera apparatuses CAMⁱ and CAM^{j} can be represented as follows:

cft^{i,j}(G_{—}Hⁱ(x))=G_{—}H^{j}^{^{−1}}(G_{—}Hⁱ(x)),xε[0,255] (formula 2)

cft^{i,j}(B_{—}Hⁱ(x))=B_{—}H^{j}^{^{−1}}(B_{—}Hⁱ(x)),xε[0,255] (formula 3)

Such conversion relationships represent the color conversion model, resulting from training, of the objects in the images captured by the camera apparatuses CAMⁱ and CAM^{j}. FIG. 2a to FIG. 2c illustrate schematic diagrams of the obtained color conversion relationships of the three color channels R, G and B respectively. In FIG. 2a-2c, the abscissa and the ordinate represent the color values in the color histograms related to the two camera apparatuses CAMⁱ and CAM^{j} for which the color conversion model is to be obtained, respectively.

As can be apparent, the foregoing description is merely a specific example of constructing the color conversion model between the camera apparatuses, and the color conversion model can alternatively be constructed in various other methods. Another specific example will be given below.

A training set including a specific number of images is selected for each of the camera apparatuses CAMⁱ and CAM^{j}, and in this example, the number of images is 1000, for example.

Color histograms R_Hⁱ, G_Hⁱ, B_Hⁱ of three color channels R, G and B of the training set of images of the camera apparatus CAMⁱ are calculated, where values of each color histogram are in the range of [0, 255]; and R_Hⁱ=[h₁ⁱ, h₂ⁱ, . . . , h_{M}_{₁}ⁱ], where M₁ represents the number of bins in the histogram, and in this example, M₁=255. The number of bins in the histogram represents a range of color values resulting from division in making statistic analysis for color values, so a bin is related to the resolution of the color histogram, i.e., the density of sparseness.

Color histograms R_H^{j}, G_H^{j}, B_H^{j} of the three color channels R, G and B of the training set of images of the camera apparatus CAM^{j} are calculated, where values of each color histogram are in the range of [0, 255]; and R_H^{j}=[h₁^{j}, h₂^{j}, h_{M}_{₁}^{j}], where M₁ represents the number of bins in the histogram, and in this example, M₁=255.

Taking the histogram of the R channel as an example, a covariance distance matrix C of the color histograms R_Hⁱ and R_H^{j} as shown in the following formula (4)) is calculated. In this matrix C, c_{m·n}=dist(hₘⁱ, hₙ^{j}), 1≦m, n≦M₁, represents the distance, which is the L₁ distance in this example, between the bins in the two histograms, i.e., dist(hₘⁱ, hₘ^{j})=|hₘⁱ−hₙⁱ|. Then the optimum route satisfying argmin(Σ_{m,nε[1 M}^{¹}_{]}c_{m·n}) is calculated in a dynamic planning method, and each node of the optimum route represents a conversion relationship corresponding to each corresponding color value in the color conversion model. The foregoing covariance distance matrix C, L₁ distance and dynamic planning method are well known in the art, so a repeated description thereof will be omitted here.

$${C}_{{M}_{1} \times {M}_{1}} = ( \begin{matrix}{C}_{1 \cdot 1} & … & {C}_{1 \cdot {M}_{1}} \\ ⋮ & ⋱ & ⋮ \\ {C}_{{M}_{1} \cdot 1} & … & {C}_{{M}_{1} \cdot {M}_{1}}\end{matrix} ) \qquad ( formula 4 )$$

where c_{m·n}=dist(hₘⁱ, hₙⁱ), 1≦m, n≦M₁.

After the color conversion model of the objects in the images captured by the different camera apparatuses is obtained, the first matching similarities between the objects in the images captured by the two camera apparatuses can be obtained based on the color conversion model. A specific example of obtaining this first matching similarity will be given below.

Given the color conversion model between the images captured by the camera apparatuses CAMⁱ and CAM^{j}, the matching similarity between the objects in the images captured by the camera apparatuses CAMⁱ and CAM^{j} is calculated particularly as follows (taking the R channel as an example):
An area corresponding to the specific object in the image captured by the camera apparatus CAMⁱ, referred here to as a sub-image area Objⁱ, and an area corresponding to any one object in the image captured by the camera apparatus CAM^{j}, referred here to as a sub-image area Obj^{j}, are obtained.
A color value of the sub-image area Objⁱ is obtained, and a converted color value is calculated in the color conversion model cft^{i,j} between the camera apparatuses as shown in the above formula (I), where a sub-image area corresponding to the converted color value will be referred below to as a sub-image area Objⁱ′.
Each of the sub-image areas Objⁱ′ and Ob^{j} is divided into a number num_w*num_h of sub-image blocks, and color histograms R_H_{m,n}(Objⁱ′) and R_H_{m,n}(Obj^{j}) are calculated in each of the sub-image blocks. Here, m=1, 2, . . . , num_w, n=1, 2, . . . , num_h, and (m, n) represents the serial number of a sub-image block. In this example, num_w=3, num_h=3, for example.
The Bhattacharyya distance between the color histograms of the corresponding sub-image blocks in the sub-image areas Objⁱ′ and Obj^{j} corresponding to the two camera apparatuses is calculated as follows:

Dist_{m,n}(R_{—}Hⁱ,R_{—}H^{j})=−ln(Σ_{xε[0 255]}{square root over (R_{—}Hⁱ(x)*R_{—}H^{j}(x)))} (formula 5)

where x represents the index value in the color histogram in the range of [0, 255].
A first matching similarity component Sim(Objⁱ, Obj^{j}), related to the R color channel, of the sub-image areas Objⁱ and Obj^{j} is calculated as follows:

$$\begin{matrix}Sim ( {Obj}^{i} , {Obj}^{j} ) = {e}^{- ( Dist ( {Obj}^{i} , {Obj}^{j} ) )} & ( formula 6 ) \\ Dist ( {Obj}^{i} , {Obj}^{j} ) = {\sum }_{m , n} \frac{{Dist}_{m , n}}{num\_w \times num\_h} & ( formula 7 )\end{matrix}$$

The foregoing process is performed for the specific object in the image captured by the camera apparatus CAMⁱ and the one or more objects in the image captured by the camera apparatus CAM^{j} to thereby obtain the respective first matching similarities between the specific object and the one or more objects in the image captured by CAM^{j}. Whether one or more objects in the image captured by the camera apparatus CAM^{j} are subjected to the foregoing process depends on practical needs.

First matching similarity components related to the other color channels, i.e., the G and B color channels, can be obtained in a similar way, and then the first matching similarity components related to the three color channels are averaged or weighted and summed or otherwise to finally obtain the first matching similarity.

The Bhattacharyya distance mentioned above is used to measure two discrete probability distributions in the statistics. It typically measures separablity between categories during categorization. In the same definition domain X, the Bhattacharyya distance between probability distributions p and q is defined as follows:

$$\begin{matrix}{D}_{B} ( p , q ) = - ln ( BC ( p , q ) ) & ( 1 ) \\ BC ( p , q ) = {\sum }_{x ∈ X} \sqrt{p ( x ) q ( x )} & ( 2 ) \\ BC ( p , q ) = \int \sqrt{p ( x ) q ( x )} d x \\ \leq BC \leq 1 \; 0 \leq {D}_{B} \leq ∞ & ( 3 )\end{matrix}$$

where (1) represents a discrete probability distribution, (2) represents a continuous probability distribution, and BC stands for the Bhattacharyya Coefficient.

For more information on the Bhattacharyya distance, for example, reference can be made to “On a measure of divergence between two statistical populations defined by their probability distributions” by Bhattacharyya, A. (1943) (Bulletin of the Calcutta Mathematical Society 35: 99-109. MR0010358) and “Bhattacharyya distance” at http://en.wikipedia.org/wiki/Bhattacharyya_distance.

As can be apparent, the foregoing use of the Bhattacharyya distance to represent the difference between the color values of the objects in the images captured by the different camera apparatuses is merely a specific example, and this difference between the color values can alternatively be obtained in various other methods.

For example the difference between the color values in the objects of the images captured by the camera apparatuses CAMⁱ and CAM^{j} can be characterized by the X² distance as shown in the following formula (8):

$$d ( {R\_H}^{i} , {R\_H}^{j} ) = {\sum }_{x} \frac{{R\_H}^{i} ( x ) - {R\_H}^{j} ( x )}{{R\_H}^{i} ( x ) + {R\_H}^{j} ( x )} \qquad ( formula 8 )$$

Alternatively the difference between the color values in the objects of the images captured by the camera apparatuses CAMⁱ and CAM^{j} can be characterized by the correlation distance as shown in the following formula (9):

$$d ( {R\_H}^{i} , {R\_H}^{j} ) = {\sum }_{x} \frac{{R\_H}^{{i}^{′}} ( x ) \cdot {R\_H}^{{j}^{′}} ( x )}{\sqrt{( {\sum }_{x} {R\_H}^{{i}^{′}} {( x )}^{2} ) ( {\sum }_{x} {R\_H}^{{j}^{′}} {( x )}^{2} )}} \\ where {R\_H}^{{i}^{′}} ( x ) = {R\_H}^{i} ( x ) - \frac{1}{w} {\sum }_{x} {R\_H}^{i} ( x ) , \qquad ( formula 9 )$$

W represents the number of bins in the color histogram, x represents the index value in the color histogram.

Furthermore, the foregoing description takes the R channel in the RGB color space merely as an example. The other channels can be processed in a similar way. Moreover, the color conversion model can alternatively be obtained by using another color space, e.g., an HSV color space etc., in a similar process to the RGB space, and a repeated description thereof will be omitted here.

Furthermore, those skilled in the art would appreciate that the similarity matching process can also be performed with various other features capable of embodying the difference between objects in images, e.g., a texture feature, in addition to a color feature. The similarity matching process performed with the texture feature is similar to the similarity matching process performed with the color feature, so a repeated description thereof will be omitted here.

Next a specific example of constructing a temporal/spatial conversion probability model of objects in images captured by different camera apparatuses will be described below.

Also assuming that the monitoring camera apparatuses in a practical monitoring scenario are numbered as CAMⁱ, i ε {1, 2, . . . , N}, where N represents the number of camera apparatuses. The actual physical distance between any two camera apparatuses CAMⁱ and CAM^{j} is Dist^{i,j}, i, j ε {1, 2, . . . , N}.

In this example, the steps of constructing a temporal/spatial conversion probability model are as follows:
Traveling speeds v^{s}, s=1, 2, . . . , M, of M specific analogous objects, e.g., persons, in the monitoring scenario including the N camera apparatuses are recorded.
The average v̅ and the variance σ of the traveling speeds of the persons are calculated as follows:

v̅=Σᵢ₌₁^{M}v^{s}/M (formula 10)

σ=\sqrt{Σᵢ₌₁^{M}}(v− v̅)²/M (formula 11)
Next the temporal/spatial conversion probability model between the camera apparatuses CAMⁱ and CAM^{j} is constructed:

$$P ( t \vert {CAM}^{i} , {CAM}^{j} ) = \frac{{e}^{\frac{{( t - \frac{{Dist}^{i , j}}{\overline{v}} )}^{2}}{2 {σ}_{t}^{2}}}}{\sqrt{2 {πσ}_{t}}} \\ where {σ}_{t} = \frac{{Dist}^{i , j}}{σ} . \qquad ( formula 12 )$$

A temporal/spatial conversion probability distribution between the camera apparatuses CAMⁱ and CAM^{j} obtained according to the temporal/spatial conversion probability model is as illustrated in FIG. 3. As can be apparent, this is a normal distribution. Therefore the temporal/spatial conversion probability distribution of objects between the camera apparatuses CAMⁱ and CAM^{j} can alternatively be described in another appropriate model capable of embodying a normal distribution.

The foregoing example has been described taking a person as a monitored object. As can be apparent, if the monitored object is not a person, then a traveling speed will be determined from a recorded speed of an object of the same category as the monitored object in the monitoring scenario.

Furthermore this temporal/spatial conversion probability model can be constructed in advance. Alternatively, this temporal/spatial conversion probability model can be constructed on-line, and then the currently used temporal/spatial conversion probability model can be updated with the newly constructed temporal/spatial conversion probability model.

The first matching similarities and the temporal/spatial conversion probability distributions between the objects in the images captured by the different camera apparatuses have been obtained above, and second matching similarities between the objects can be determined from these parameters to thereby determine whether the objects match with each other as described in a specific example to be given later.

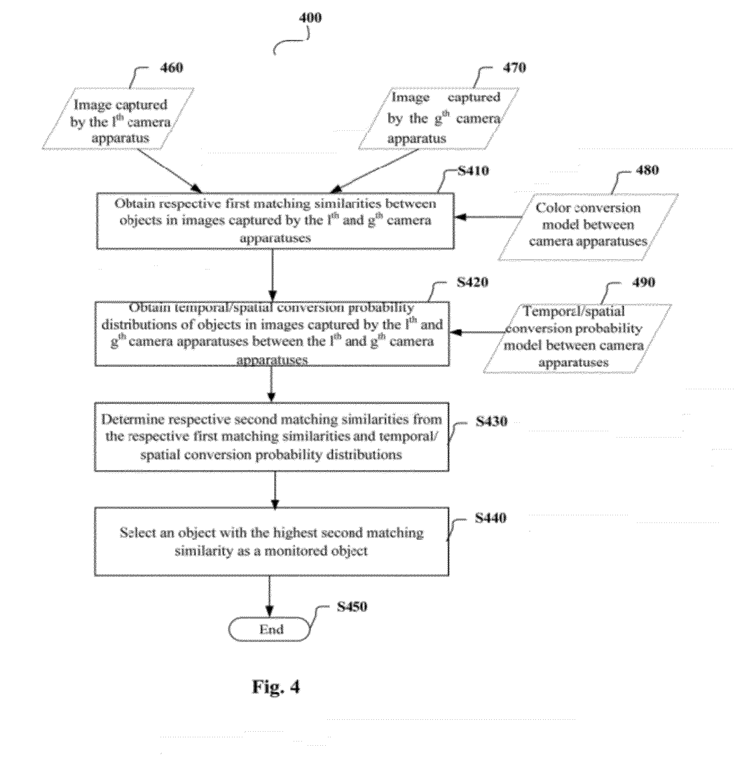

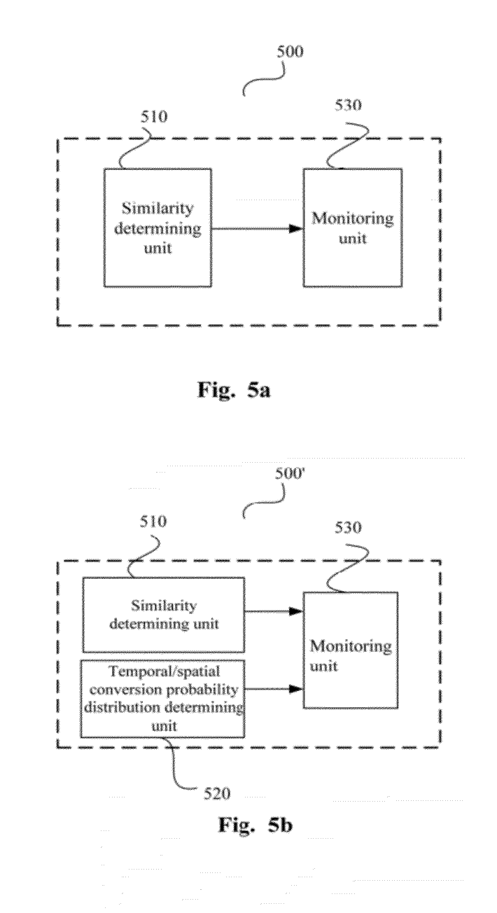

A specific implementation of obtaining a route of the specific object among any K camera apparatuses in the monitoring system including the N camera apparatuses by the object monitoring process will be given below with reference to FIG. 4.

As illustrated in FIG. 4, at S410, the l^{th} camera apparatus among the K camera apparatuses is selected randomly, and respective first matching similarities between a specific object in an image 460 captured by the l^{th} camera apparatus and one or more objects in an image 470 captured by the g^{th} camera apparatus are obtained respectively by using an inter-camera-apparatus color conversion model 480. Here, g=1, . . . , K, and K is an integer greater than or equal to 2 and less than or equal to N, g and l are integers greater than or equal to 1 and less than or equal to K, and l≠g. That is, the l^{th} camera apparatus and the g^{th} camera apparatus are any camera apparatuses among the foregoing K camera apparatuses. For example, these first matching similarities can be obtained by using the method detailed above with reference to FIG. 2a to FIG. 2c.

At S420, temporal/spatial conversion probability distributions of the specific object and the one or more objects in the image captured by the g^{th} camera apparatus between the positions of these two camera apparatuses are respectively obtained by using an inter-camera-apparatus temporal/spatial conversion probability model 490 according to the time when the specific object leaves the l^{th} camera apparatus and the times when the respective objects enter the g^{th} camera apparatus. For example, these temporal/spatial conversion probability distributions can be obtained by using the method 3 described in detail above with reference to FIG. 3. In a specific implementation, the temporal parameter t described above in the formula (12) is equal respectively to the differences between the time when the specific object leaves the l^{th} camera apparatus and the times when the respective objects enter the g^{th} camera apparatus. Thus the respective temporal/spatial conversion probability distributions of the specific object and the one or more objects in the image captured by the g^{th} camera apparatus between these two camera apparatuses can be obtained.

At S430, respective second matching similarities between the specific object in the image captured by the l^{th} camera apparatus and the one or more objects in the image captured by the g^{th} camera apparatus are determined based on the obtained respective first matching similarities and temporal/spatial conversion probability distributions. As a specific example of determining the second matching similarities, for example, the products of the corresponding first matching similarities and temporal/spatial conversion probability distributions can be taken as the second matching similarities, or the sums or the weighted averages of the normalized corresponding first matching similarities and temporal/spatial conversion probability distributions can be taken as the second matching similarities.

At S440, the object with the highest obtained second matching similarity as an object matching with the foregoing specific object (i.e., an object initially determined as a monitored object). In a preferred embodiment, after the monitored object matching with the specific object in each of the K camera apparatuses is obtained in the foregoing process, the times when the monitored object appears in the K camera apparatuses and the positions of the K camera apparatuses can be obtained to thereby generate a route of the monitored object among the K camera apparatuses.

In a preferred embodiment, the object corresponding to the highest obtained second matching similarity can be determined as a monitored object, i.e., an object matching with the specific object, only if this second matching similarity is greater than a predetermined threshold. Such a situation may arise in practice that if the second matching similarity of a certain object is the highest, but the object does not actually appear in a corresponding camera apparatus, then the object may be mistaken for an object matching with the specific object, that is, a matching error may arise. The rate of matching errors can be further lowered by setting the foregoing predetermined threshold to thereby ensure that the object which does not appear in the corresponding camera apparatus will not be determined as a monitored object matching with the foregoing specific object. This predetermined threshold can be adjusted or set as needed in practice. For example, the predetermined threshold can be obtained experimentally or empirically.

Furthermore, the foregoing object monitoring process can further include predicating a future route of a certain object, that is, estimating a possible future route of the object from its current motion direction. This predication of a future route can further improve the efficiency of object monitoring.

It shall be noted that in FIG. 4, firstly the process of obtaining the first matching similarities and then the process of obtaining the temporal/spatial conversion probability distributions are performed, but this is merely an example, and these two processes can be performed reversely for the same purpose of object monitoring.

Correspondingly, an embodiment of the present invention also provides a device for monitoring an object in images captured by N camera apparatuses. FIG. 5a illustrates a simplified block diagram of this device. As illustrated in FIG. 5a, the device 500 includes a similarity determining unit 510 configured to, for the i^{th} camera apparatus among the N camera apparatuses, perform feature conversion between a feature of an object in an image captured by the i^{th} camera apparatus and a feature of an object in an image captured by the j^{th} camera apparatus according to a pre-constructed feature conversion model between the camera apparatuses, and obtain respective first matching similarities of a specific object in the image captured by the i^{th} camera apparatus respectively with respect to one or more objects in the image captured by the j^{th} camera apparatus based on the result of feature conversion. Here N is an integer greater than or equal to 2, i is an integer greater than or equal to 1 and less than or equal to N, j=1, 2, . . . , N, j is an integer, and i≠j. The device 500 further includes a monitoring unit 530 configured to determine an object matching with the specific object in the image captured by the j^{th} camera apparatus based on the respective first matching similarities to thereby monitor the specific object.

In an alternative solution of the device 500 illustrated in FIG. 5b, in addition to the similarity determining unit 510 and the monitoring unit 530, the object monitoring device 500′ further includes a temporal/spatial conversion probability distribution determining unit 520 configured to obtain, for the i^{th} camera apparatus among the N camera apparatuses, respective temporal/spatial conversion probability distributions of the specific object in the image captured by the i^{th} camera apparatus and the one or more objects in the image captured by the j^{th} camera apparatus between the positions of the i^{th} camera apparatus and the j^{th} camera apparatus, respectively, according to a temporal/spatial conversion probability model between the camera apparatuses. The monitoring unit 530 then determines the object matching with the specific object in the image captured by the j^{th} camera apparatus based on both the respective first matching similarities obtained by the similarity determining unit 510 and the respective temporal/spatial conversion probability distributions obtained by the temporal/spatial conversion probability distribution determining unit 520.

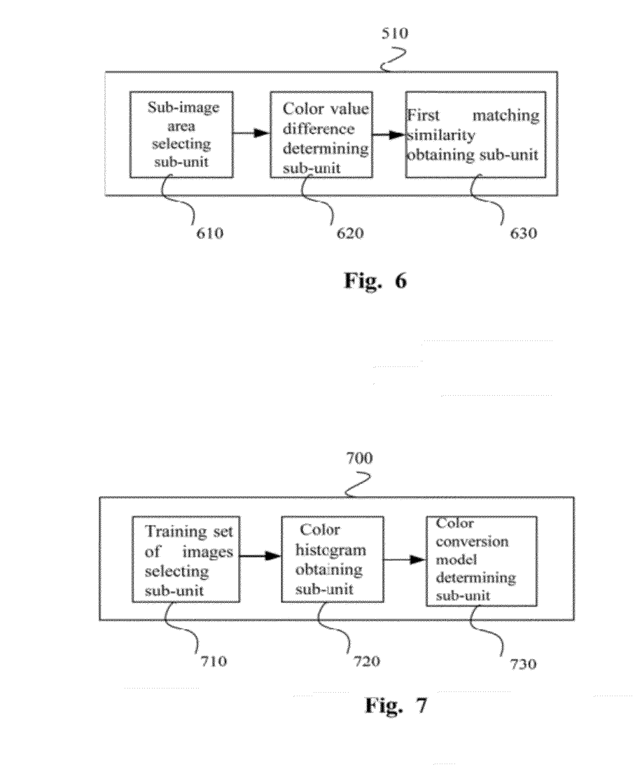

In a specific implementation of the device 500 and/or 500′ in FIG. 5a and FIG. 5b, the first matching similarities are obtained by using a color conversion model. Correspondingly in a specific example as illustrated in FIG. 6, the similarity determining unit 510 illustrated in FIG. 5a and FIG. 5b can include: a sub-image area selecting sub-unit 610 configured to select a sub-image area Objⁱ corresponding to the specific object in the image captured by the i^{th} camera apparatus and a sub-image area Obj^{j} corresponding to any one object in the image captured by the j^{th} camera apparatus; a color value difference determining sub-unit 620 configured to obtain the difference between color values of the two sub-image areas according to a color conversion model between the i^{th} camera apparatus and the j^{th} camera apparatus; and a first matching similarity obtaining sub-unit 630 configured to obtain the first matching similarity between the specific object and any one object according to the obtained difference between color values.

In another specific implementation of the device 500 and/or 500′ in FIGS. 5a and 5b, the device can further include a color conversion model constructing unit. FIG. 7 illustrates a simplified structural block diagram of this color conversion model constructing unit 700. As illustrated, the color conversion model constructing unit 700 includes: a training set of images selecting sub-unit 710 configured to select a predetermined number of images captured by each of the i^{th} camera apparatus and the j^{th} camera apparatus, for which the color conversion model is to be constructed, as a training set of images; a color histogram obtaining sub-unit 720 configured to obtain a first color histogram of a first training set of images for the i^{th} camera apparatus and a second color histogram of a second training set of images for the j^{th} camera apparatus, respectively; and a color conversion model determining sub-unit 730 configured to determine a conversion relationship between the color values of the object in the image captured by the first camera apparatus and the object in the image captured by the second camera apparatus according to the first color histogram and the second color histogram, as the color conversion model between the i^{th} camera apparatus and the j^{th} camera apparatus.

As described above, the color histogram obtaining sub-unit 720 can obtain color histograms of R, G and B color channels for the i^{th} camera apparatus and the j^{th} camera apparatus. The color conversion model determining sub-unit 730 can calculate the color conversion model between the i^{th} camera apparatus and the j^{th} camera apparatus according to the color histograms obtained by the color histogram obtaining sub-unit 720, for example, by using the method described above in connection with the formulas (1)-(3). Reference can be made to the foregoing related description for details of the process, so a repeated description thereof will be omitted here.

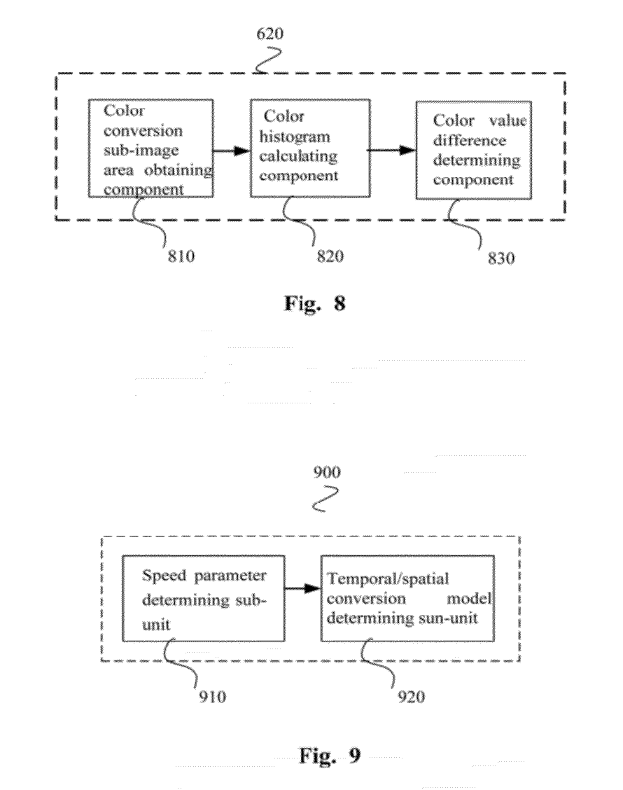

In a specific implementation of the color value difference determining sub-unit 620 as illustrated in FIG. 6, the color value difference determining sub-unit 620 as illustrated in FIG. 8 can include: a color conversion sub-image area obtaining component 810 configured to obtain a converted color value of the color value of the sub-image area Objⁱ in the i^{th} camera apparatus by using the color conversion model between the i^{th} camera apparatus and the j^{th} camera apparatus, where the converted color value corresponds to a sub-image area Objⁱ′ of the i^{th} camera apparatus resulting from color conversion; a color histogram calculating component 820 configured to divide each of the sub-image area Objⁱ′ resulting from color conversion and the sub-image area Objⁱ in the j^{th} camera apparatus into a number num_w*num_h of sub-image blocks, and to calculate color histograms R_H_{m,n}(Objⁱ′), G_H_{m,n}(Objⁱ′), B_H_{m,n}(Objⁱ′) and R_H_{m,n}(Obj^{j}), G_H_{m,n}(Obj^{j}), B_H_{m,n}(Obj^{j}) respectively corresponding to the R, G and B color channels in each of the sub-image blocks, where m=1, . . . , num_w; n=1, . . . , num_h, and num_w and num_h are positive integers greater than or equal to 1; and a color value difference determining component 830 configured to determine the distances, e.g., the Bhattacharyya distances, the correlation distances, etc., between the color histograms, corresponding respectively to the R, G and B color channels, of the sub-image clocks corresponding to each other in the sub-image areas Objⁱ and Objⁱ, as the difference between the color values of the sub-image area Objⁱ and the sub-image area Obj^{j}. For example, the color value difference determining sub-unit 620 and the constituent components thereof can be configured to perform the method for determining the difference of color values between the different camera apparatuses as described above in connection with the formulas (5)-(9), and reference can be made to the foregoing related description for details, so a repeated description thereof will be omitted here.

As illustrated in FIG. 6, after the color value difference determining sub-unit 620 obtains the difference between the color values, the first matching similarity obtaining sub-unit can obtain matching similarity components Sim, corresponding respectively to the R, G and B color channels, of the sub-image areas Objⁱ and Obj^{j} according to the distances e.g., the Bhattacharyya distances, etc., between the corresponding sub-image blocks, and then obtain the average of the matching similarity components Sim corresponding to the R, G and B color channels as the first matching similarity. Reference can be made to, for example, the foregoing description in connection with the formulas (6)-(7) for a specific method for obtaining the first matching similarity, so a repeated description thereof will be omitted here.

FIG. 9 illustrates a specific implementation of the temporal/spatial conversion probability model determining unit 520 as one of the constituent units of the device 500′ illustrated in FIG. 5b. As illustrated, the temporal/spatial conversion probability model determining unit 520 includes: a speed parameter determining sub-unit 910 configured to obtain, based on typical traveling speeds of M objects of the same category as the specific object in the monitoring system, the average v̅ and the variance σ of the traveling speeds of the objects of the category; and a temporal/spatial conversion model determining sun-unit 920 configured to construct a temporal/spatial conversion probability model P(t|CAMⁱ, CAM^{j}) between the i^{th} camera apparatus and the j^{th} camera apparatus according to the obtained average v̅ and the variance σ of the traveling speeds. For example, the unit 520 and the respective constituent components can perform the process described above in connection with the formulas (10)-(12). Reference can be made to the foregoing related description for details, so a repeated description thereof will be omitted here.

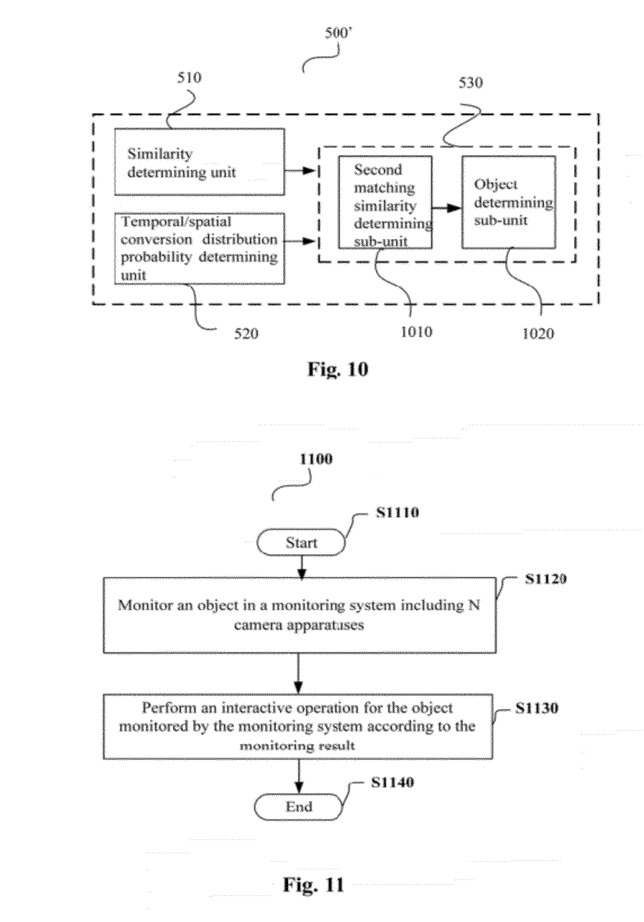

FIG. 10 illustrates a specific implementation of the device 500′ illustrated in FIG. 5b, where the monitoring unit 530 includes: a second matching similarity determining sub-unit 1010 configured to determine respective second matching similarities between the specific object in the image captured by the i^{th} camera apparatus and the respective objects in the image captured by the j^{th} camera apparatus based on the respective first matching similarities determined by the similarity determining unit 510 and the respective temporal/spatial conversion probability distributions determined by the temporal/spatial conversion probability distribution determining unit 520; and an object determining sub-unit 1020 configured to determine an object with the highest second matching similarity as a monitored object matching with the specific object. In a preferred embodiment, the object determining sub-unit 1020 can be further configured to obtain the times when the monitored object appear in any K camera apparatuses among the N camera apparatuses and the positions of the K camera apparatuses according to the matching result to thereby generate a route of the monitored object among the K camera apparatuses. As an additional or alternative function, the object determining sub-unit 1020 can also be configured to estimate a future possible route of the determined monitored object according to the motion direction of the monitored object.

The device and the respective constituent components thereof illustrated in FIG. 5 to FIG. 10 can be configured to perform the monitoring method according to the embodiments of the invention described with reference to FIG. 1 to FIG. 4 and can achieve corresponding technical benefits. Reference can be made to the foregoing related description for details, so a repeated description thereof will be omitted here.

In addition to being embodied as a standalone functional device, the foregoing device for monitoring an object in images captured by N camera apparatuses according to the embodiments of the invention can also be integrated into an existing camera apparatus, e.g., a camera, so this camera apparatus can monitor an object in a monitoring system including the N camera apparatuses. Therefore this camera apparatus with a monitoring function across cameras shall also be construed as coming into the scope of the invention.

According to a further embodiment of the invention, there is provided an operating method in a monitoring system. FIG. 11 illustrates a simplified flow chart of this operating method 1100. As illustrated, the method 1100 includes: at S1120, an object in a monitoring system is monitored by the method for monitoring an object in images captured by N camera apparatuses as described above with reference to FIG. 1 to FIG. 4, where the monitoring system includes the N camera apparatuses; and at S1130, an interactive operation is performed for the object monitored by the monitoring system based on the monitoring result.

As can be apparent, this operating method according to the embodiment of the invention is actually a specific application of the object monitoring method described above with reference to FIG. 1 to FIG. 4,

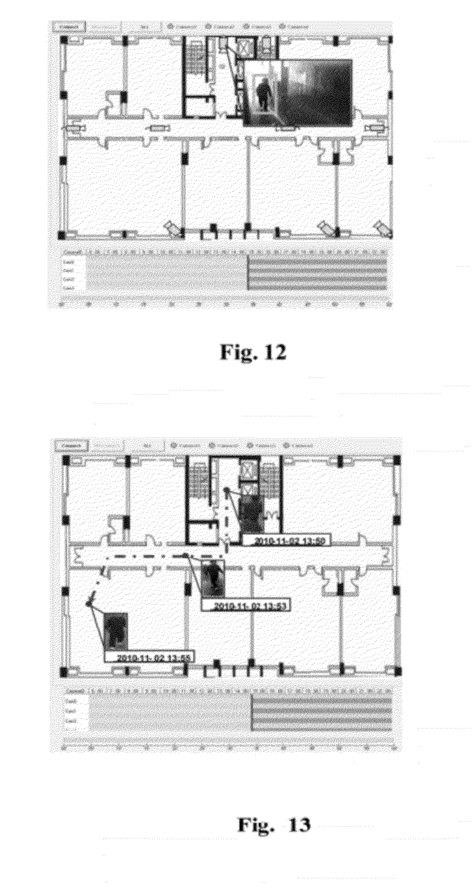

FIG. 12 illustrates a specific scenario of an interactive operation performed by using this operating method. As illustrated in FIG. 12, the type, the position, the motion direction, etc., of a monitored object (e.g., a person) are displayed in an electronic map upon detection of the monitored object.

In another interactive operation scenario (not illustrated), in the event that the monitoring system detects occurrence of an abnormal event, a real-time image and/or sound of a camera apparatus located at the place, where the abnormal event occurs, is displayed in a virtual electronic map corresponding to the monitoring system, and/or abstract information of a history monitoring video related to the place is replayed and displayed as needed.

FIG. 13 illustrates a further specific scenario of an interactive operation performed by using this operating method. As illustrated, in the event of selecting a specific monitored object in a virtual electronic map corresponding to the monitoring system, a history global route or local route of the specific object among the N camera apparatuses is generated and displayed on-line (for example, the route of the monitored object is illustrated in a thick dotted and dashed line), and/or a history monitoring video of an area through which the specific monitored object passed is replayed and displayed as needed. This scenario relates to online retrieval. Furthermore, when history monitoring information of the monitoring system is searched for a specific monitored object, a history global route or local route of the specific monitored object is generated and displayed, and/or history monitoring information captured by a camera apparatus comprised in an area through which the specific monitored object passed is replayed as needed. This scenario relates to offline retrieval.

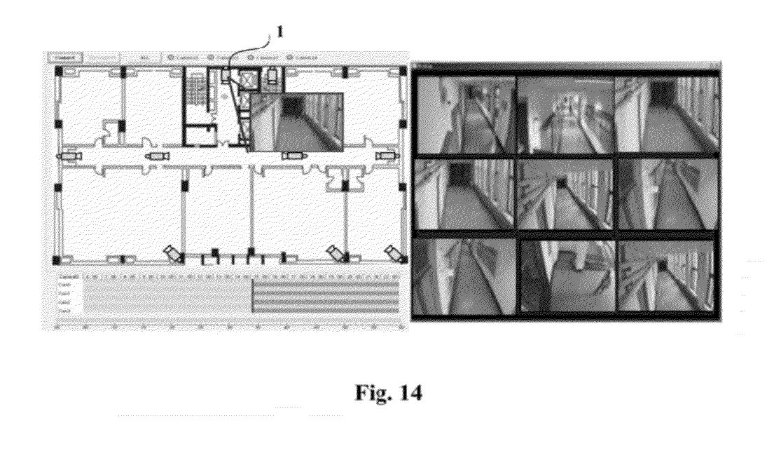

FIG. 14 illustrates still another specific scenario of an interactive operation performed by using this operating method. As illustrated, the monitoring system further comprises real-time monitoring and displaying apparatuses, e.g., TV background walls (as illustrated on the right hand of FIG. 14) related to the N camera apparatuses, and icons corresponding to the N camera apparatuses (as illustrated on the left hand of FIG. 14) are included in a virtual electronic map corresponding to the monitoring system. In an interactive operation, when a specific icon in the virtual electronic map, for example an icon denoted with the reference numeral “1”, is selected, the real-time monitoring and displaying apparatus related to the camera apparatus corresponding to the specific icon displays the image captured by the camera apparatus in a real time way.

Other embodiments of the present invention also provide a monitoring system which can implement the operating method as described above in conjunction with FIGS. 11-14. Such monitoring system can include: N camera apparatuses; a monitoring device; and an interface configured to receive an operation instruction and output monitoring information. For example, the monitoring device can be implemented as any one of the monitoring devices as described above in conjunction with FIGS. 5-10.

According to an exemplary embodiment of the monitoring system, the interface can be configured to, in response to an abnormal event detected by the monitoring system, display a real-time image and/or sound of a camera apparatus which captured the abnormal event, in a virtual electronic map corresponding to the monitoring system, and/or replay abstract information of a history monitoring video related to the abnormal event.

According to another exemplary embodiment of the monitoring system, the interface can include a virtual electronic map corresponding to the monitoring system; and the monitoring unit can be configured to, in response to the operation instruction of selecting a specific monitored object in the virtual electronic map, generate a history global route of the specific object among the N camera apparatuses. The interface can be configured to display the history global route on the virtual electronic map and/or replay a history monitoring video of an area through which the specific monitored object passed.

According to still another exemplary embodiment of the monitoring system, the interface can include a virtual electronic map corresponding to the monitoring system; and the monitoring unit can be configured to, in response to the operation instruction of searching history monitoring information of the monitoring system for a specific monitored object, and generate a history global route of the specific monitored object. The interface can be configured to display the history global route of the specific monitored object on the virtual electronic map and/or replay history monitoring information captured by a camera apparatus comprised in an area through which the specific monitored object passed.

According to another exemplary embodiment of the monitoring system, the interface can include real-time monitoring and displaying apparatuses related to the N camera apparatuses and a virtual electronic map corresponding to the monitoring system, wherein icons corresponding to the N camera apparatuses are comprised in the virtual electronic map. The interface can be configured to, in response to the operation instruction of selecting a specific icon in the virtual electronic map, make the real-time monitoring and displaying apparatus related to the camera apparatus corresponding to the specific icon display the image captured by the camera apparatus.

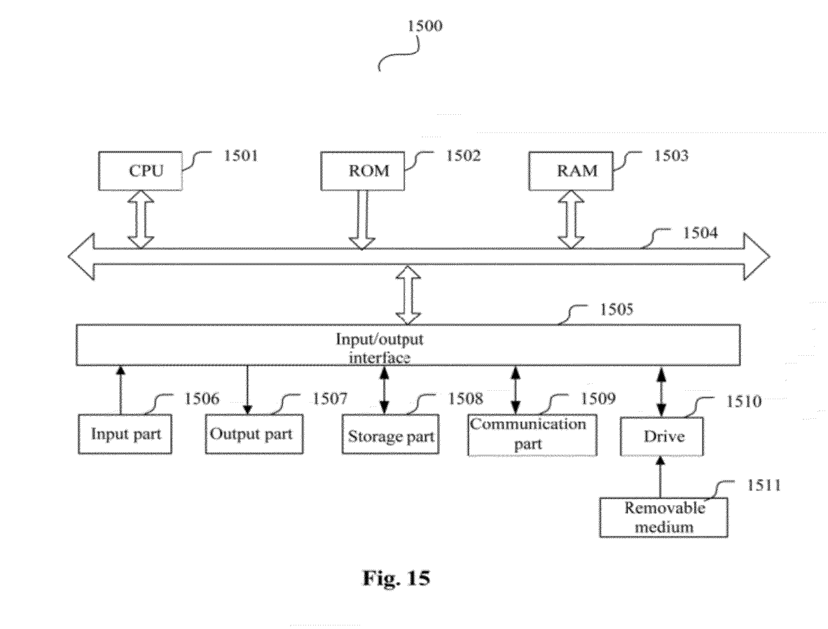

Finally it shall be noted that the respective constituent components of the device, the apparatus and the system and the series of process of the method according to the foregoing respective embodiments of the invention can be implemented in hardware, software and/or firmware. In the event of being implemented in software and/or firmware, a program constituting the software can be installed from a storage medium or a network to a computer with a dedicated hardware structure, e.g., a general-purpose personal computer 1500 illustrated in FIG. 15, which computer can perform various functions, processes, etc., described in the foregoing embodiments when various programs are installed thereon to thereby act as an example of an information processing device capable of performing the object monitoring method according to the embodiments of the invention.

In FIG. 15, a Central Processing Unit (CPU) 1501 performs various processes according to programs stored in a Read Only Memory (ROM) 1502 or loaded from a storage part 1508 into a Random Access Memory (RAM) 1503. The RAM 1503 also store data required when the CPU 1501 performs the various processes as needed.

The CPU 1501, the ROM 1502 and the RAM 1503 are connected to each other via a bus 1504 to which an input/output interface 1505 is also connected.

The following components are connected to the input/output interface 1505: an input part 1506 including a keyboard, a mouse, etc.; an output part 1507 including a display, e.g., a Cathode Ray Tube (CRT), a Liquid Crystal Display (LCD), etc., a speaker, etc.; the storage port 1508 including a hard disk, etc.; and a communication part 1509 including a network interface card, e.g., an LAN card, a modem, etc. The communication part 1509 performs a communication process over a network, e.g., the Internet.

A drive 1510 is also connected to the input/output interface 1505 as needed. A removable medium 1511, e.g., a magnetic disk, an optical disk, an optic-magnetic disk, a semiconductor memory, etc., can be installed on the driver 1510 as needed, so that a computer program fetched therefrom can be installed into the storage part 1508 as needed.

In the event that the foregoing series of processes are performed in software, a program constituting the software is installed from a network, e.g., the Internet, or a storage medium, e.g., the removable medium 1511.

Those skilled in the art shall appreciate that this storage medium will not be limited to the removable medium 1511 illustrated in FIG. 15 in which the program is stored and which is distributed separately from the device to provide the user with the program. Examples of the removable medium 1511 include a magnetic disk (including a Floppy Disk (a registered trademark)), an optical disk (including Compact Disk-Read Only memory (CD-ROM) and a Digital Versatile Disk (DVD)), an optic-magnetic disk (including a Mini Disk (MD) (a registered trademark)) and a semiconductor memory. Alternatively, the storage medium can be the ROM 1502, the hard disk included in the storage port 1508, etc., in which the program is stored and which is distributed together with the device including the same to the user.

As can be apparent, an embodiment of the invention further discloses a program product on which machine readable instruction codes are stored, wherein the instruction codes upon being read and executed by a machine can make the machine perform the method for monitoring an object in images captured by N camera apparatuses or the operating method in a monitoring system according to the foregoing embodiments of the invention. Also another embodiment of the invention further provides a storage medium on which machine readable instruction codes are embodied, wherein the instruction codes upon being read and executed by a machine can make the machine perform the method for monitoring an object in images captured by N camera apparatuses or the operating method in a monitoring system according to the foregoing embodiments of the invention.

In the foregoing description of the embodiments of the invention, a feature described and/or illustrated with respect to an implementation can be used identically or similarly in one or more other implementations, or used in combination with or in place of a feature in the other implementation(s).

It shall be noted that the term “including/comprising” and “includes/comprises” as used in this context indicates presence of a feature, an element, a step or a component but does not preclude presence or addition of one or more other features, elements, steps or components. Such ordinal terms as “first”, “second”, etc., do not indicate an order in which features, elements, steps or components defined by these terms are implemented or their degrees of importance but are merely intended to distinguish these features, elements, steps or components from each other for the sake of clarity.

Furthermore, the methods and the processes according to the respective embodiments of the invention will not necessarily be performed in the sequential order described in the specification but can alternatively be performed sequentially in another order, concurrently or separately. Therefore the scope of the invention shall not be limited by the order in which the various methods and processes are performed as described in the specification. Moreover the functions or component configurations described in the respective different embodiments or specific examples in the specification can be combined arbitrarily with each other as needed.

According to foregoing descriptions, the embodiments of the present invention can also be configured as, but not limited to, the solutions below.

Solution 1. A monitoring method for monitoring an object in images captured by N camera apparatuses, comprising: performing, for an ith camera apparatus among the N camera apparatuses, the operations of: performing feature conversion between a feature of an object in an image captured by the ith camera apparatus and a feature of an object in an image captured by a jth camera apparatus according to a pre-constructed feature conversion model between the camera apparatuses, and obtaining respective first matching similarities of a specific object in the image captured by the ith camera apparatus respectively with respect to one or more objects in the image captured by the jth camera apparatus based on the result of feature conversion, wherein N is an integer greater than or equal to 2, i is an integer greater than or equal to 1 and less than or equal to N, j=1, 2, . . . , N, j is an integer, and i≠j; and determining an object matching with the specific object in the image captured by the jth camera apparatus based on the respective first matching similarities to thereby monitor the specific object.

Solution 2. The monitoring method according to Solution 1, further comprising: obtaining respective temporal/spatial conversion probability distributions of the specific object in the image captured by the ith camera apparatus and the one or more objects in the image captured by the jth camera apparatus between the positions of the ith camera apparatus and the jth camera apparatus, respectively, according to a temporal/spatial conversion probability model between the camera apparatuses; wherein the determining an object matching with the specific object in the image captured by the jth camera apparatus is performed based on the respective first matching similarities and the respective temporal/spatial conversion probability distributions.

Solution 3. The monitoring method according to Solution 1 or 2, wherein the feature conversion model is a color conversion model, and the color conversion model between the i^{th} camera apparatus and the j^{th} camera apparatus represents a correspondence relationship between a color value of the object in the image captured by the i^{th} camera apparatus and a color value of the object in the image captured by the jthⱼ camera apparatus.

Solution 4. The monitoring method according to Solution 3, wherein the first matching similarity between the specific object in the image captured by the ith camera apparatus and any one object in the image captured by the jth camera apparatus is obtained by: selecting a sub-image area Obji corresponding to the specific object in the image captured by the ith camera apparatus and a sub-image area Objj corresponding to the any one object in the image captured by the jth camera apparatus; obtaining the difference between the color values of the two sub-image areas according to the color conversion model between the ith camera apparatus and the jth camera apparatus; and obtaining the first matching similarity between the specific object and the any one object according to the obtained difference between the color values.

Solution 5. The monitoring method according to Solution 2, wherein the temporal/spatial conversion probability model between the ith camera apparatus and the jth camera apparatus is constructed by: constructing a temporal/spatial conversion probability model, in a normal distribution, of the specific object between the ith camera apparatus and the jth camera apparatus based on a typical traveling speed of an object of the same category as the specific object in a monitoring system comprising the N camera apparatuses and a positional relationship between the ith camera apparatus and the jth camera apparatus.

Solution 6. The monitoring method according to Solution 3, wherein the color conversion model between the camera apparatuses is constructed by: selecting a predetermined number of images captured by each of the ith camera apparatus and the jth camera apparatus, for which the color conversion model is to be constructed, as a training set of images; obtaining a first color histogram of a first training set of images for the ith camera apparatus and a second color histogram of a second training set of images for the jth camera apparatus, respectively; and determining a conversion relationship between the color values of the object in the image captured by the first camera apparatus and the object in the image captured by the second camera apparatus according to the first color histogram and the second color histogram, as the color conversion model between the ith camera apparatus and the jth camera apparatus.

Solution 7. The monitoring method according to Solution 6, wherein: the obtaining the first color histogram and the second color histogram respectively comprises obtaining color histograms of three color channels R, G and B of the first training set of images and the second training set of images, respectively; the determining the color conversion model between the ith camera apparatus and the jth camera apparatus comprises: obtaining the color value in the second color histogram which is closest to the color value in the first color histogram for each of the three color channels R, G and B respectively; and determining the color conversion model between the ith camera apparatus and the jth camera apparatus according to a correspondence relationship between the obtained closest color values.

Solution 8. The monitoring method according to Solution 7, wherein: the color conversion model between the ith camera apparatus and the jth camera apparatus is determined in the formulas of:

cft^{i,j}(R_{—}Hⁱ(x))=R_{—}H^{j}^{^{−1}}(R_{—}Hⁱ(x)),xε[0 255]

cft^{i,j}(G_{—}Hⁱ(x))=G_{—}H^{j}^{^{−1}}(G_{—}Hⁱ(x)),xε[0 255]

cft^{i,j}(B_{—}Hⁱ(x))=B_{—}H^{j}^{^{−1}}(B_{—}Hⁱ(x)),xε[0 255]

wherein cfti,j represents the color conversion model between the ith camera apparatus and the jth camera apparatus, R_Hⁱ(x), G_Hⁱ(x) and B_Hⁱ(x) represent the values of the color histograms of the R, G and B color channels of the ith camera apparatus respectively, R_H^{j}(x), G_H^{j}(x) and B_H^{j}(x) represent the values of the color histograms of the R, G and B channels of the jth camera apparatus, x represents an index value in the color histogram in the range of [0, 255].

Solution 9. The monitoring method according to Solution 8, wherein: the obtaining the difference between the color values of the two sub-image areas according to the color conversion model between the i^{th} camera apparatus and the j^{th} camera apparatus comprises: obtaining a converted color value of the color value of the sub-image area Objⁱ in the i^{th} camera apparatus from the color conversion model between the i^{th} camera apparatus and the j^{th} camera apparatus, the converted color value corresponding to a sub-image area Objⁱ′ of the i^{th} camera apparatus resulting from color conversion; dividing each of the sub-image area Objⁱ′ resulting from color conversion and the sub-image area Objⁱ′ in the j^{th} camera apparatus into a number num_w*num_h of sub-image blocks, and calculating color histograms R_H_{m,n}(Objⁱ′), G_H_{m,n}(Obj^{j}′), B_H_{m,n}(Objⁱ′) and R_H_{m,n}(Obj^{j}), G_H_{m,n}(Obj^{j}), B_H_{m,n}(Obj^{j}) respectively corresponding to the R, G and B color channels in each of the sub-image blocks, wherein m=1, . . . , num_w; n=1, . . . , num_h, and num_w and num_h are positive integers greater than or equal to 1; and determining the distances between the color histograms, corresponding respectively to the R, G and B color channels, of the sub-image clocks corresponding to each other in the sub-image areas Objⁱ′ and Obj^{j}, as the difference between the color values of the sub-image area Objⁱ and the sub-image area Obj^{j}; and the obtaining the first matching similarity according to the obtained difference between the color values comprises: obtaining matching similarity components Sim, corresponding respectively to the R, G and B color channels, of the sub-image areas Objⁱ and Obj^{j} according to the distances;

$$Sim ( {Obj}^{i} , {Obj}^{j} ) = {e}^{- ( Dist ( {Obj}^{i} , {Obj}^{j} ) )}$$

$$Dist ( {Obj}^{i} , {Obj}^{j} ) = {\sum }_{m , n} \frac{{Dist}_{m , n}}{num\_w \times num\_h}$$

wherein Dist_{m,n} represents the distances between the color histograms, corresponding respectively to the R, G and B color channels, of the sub-image blocks corresponding to each other in the sub-image areas Objⁱ′ and Obj^{j}, and averaging the matching similarity components Sim corresponding to the R, G and B color channels as the first matching similarity.

Solution 10. The monitoring method according to Solution 5, wherein the constructing a temporal/spatial conversion probability model, in normal distribution, of the specific object between the i^{th} camera apparatus and the j^{th} camera apparatus comprises: obtaining, based on typical traveling speeds of M objects of the same category as the specific object in the monitoring system, the average v̅ and the variance σ of the traveling speeds of the objects of the category as:

v̅=Σₛ₌₁^{M}v^{s}/M,σ=\sqrt{Σₛ₌₁^{M}}(v− v̅)²/M

wherein v^{s} represents the traveling speed of the s^{th} object of the category, and s=1, 2, . . . , M; and
constructing the temporal/spatial conversion probability model P(t|CAMⁱ, CAM^{j})) between the i^{th} camera apparatus and the j^{th} camera apparatus according to the obtained average v̅ and the variance σ of the traveling speeds:

$$P ( t \vert {CAM}^{i} , {CAM}^{j} ) = \frac{{e}^{\frac{{( t - \frac{{Dist}^{i , j}}{\overline{v}} )}^{2}}{2 {σ}_{t}^{2}}}}{\sqrt{2 {πσ}_{t}}}$$

$$wherein {σ}_{t} = \frac{{Dist}^{i , j}}{σ}$$

wherein CAMⁱ, CAM^{j} represent the i^{th} camera apparatus and the j^{th} camera apparatus, t represents a period of time elapsing from the specific object leaving the i^{th} camera apparatus to entering the j^{th} camera apparatus, and Dist^{i,j} represents the distance between the i^{th} camera apparatus and the j^{th} camera apparatus.

Solution 11. The monitoring method according to Solution 2, wherein the monitoring the specific object based on the respective first matching similarities and the respective temporal/spatial conversion probability distributions comprises: determining respective second matching similarities between the specific object in the image captured by the ith camera apparatus and the respective objects in the image captured by the jth camera apparatus based on the respective first matching similarities and the respective temporal/spatial conversion probability distributions; and determining an object with the highest second matching similarity as a monitored object matching with the specific object, and obtaining the times when the monitored object appears in any K camera apparatuses among the N camera apparatuses and the positions of the K camera apparatuses according to the matching result to thereby generate a route of the monitored object among the K camera apparatuses, wherein K is an integer greater than or equal to 2 and less than or equal to N.

Solution 12. The monitoring method according to Solution 11, wherein an object with the highest second matching similarity above a predetermined threshold is determined as the monitored object matching with the specific object.

Solution 13. The monitoring method according to Solution 11, further comprising: estimating a future possible route of the determined monitored object according to the motion direction of the monitored object.

Solution 14. The monitoring method according to Solution 11, wherein the determining the second matching similarities based on the respective first matching similarities and the respective temporal/spatial conversion probability distributions comprises: taking a product of, a value obtained by addition after normalization of, or a weighted average value after normalization of the first matching similarity and the temporal/spatial conversion probability distribution related to any one object in the image captured by the jth camera apparatus, as the second matching similarity corresponding to the any one object.

Solution 15. A monitoring device for monitoring an object in images captured by N camera apparatuses, comprising: a similarity determining unit configured to, for an ith camera apparatus among the N camera apparatuses, perform feature conversion between a feature of an object in an image captured by the ith camera apparatus and a feature of an object in an image captured by a jth camera apparatus according to a pre-constructed feature conversion model between the camera apparatuses, and obtain respective first matching similarities of a specific object in the image captured by the ith camera apparatus respectively with respect to one or more objects in the image captured by the jth camera apparatus based on the result of feature conversion, wherein N is an integer greater than or equal to 2, i is an integer greater than or equal to 1 and less than or equal to N, j=1, 2, . . . , N, j is an integer, and i≠j; and a monitoring unit configured to determine an object matching with the specific object in the image captured by the jth camera apparatus based on the respective first matching similarities to thereby monitor the specific object.

Solution 16. The monitoring device according to Solution 15, further comprising: a temporal/spatial conversion probability distribution determining unit configured to obtain, for the ith camera apparatus among the N camera apparatuses, respective temporal/spatial conversion probability distributions of the specific object in the image captured by the ith camera apparatus and the one or more objects in the image captured by the jth camera apparatus between the positions of the ith camera apparatus and the jth camera apparatus, respectively, according to a temporal/spatial conversion probability model between the camera apparatuses; and the monitoring unit is configured to determine the object matching with the specific object in the image captured by the jth camera apparatus based on the respective first matching similarities and the respective temporal/spatial conversion probability distributions.

Solution 17. A camera apparatus, comprising the monitoring device according to Solution 15 or 16.

Solution 18. An operating method in a monitoring system, comprising: monitoring an object in a monitoring system by the object monitoring method according to any one of Solutions 1-14, wherein the monitoring system comprises the N camera apparatuses; and performing an interactive operation for the object monitored by the monitoring system based on the monitoring result.

Solution 19. The operation method according to Solution 18, wherein the performing an interactive operation for the object monitored by the monitoring system comprises: in the event that the monitoring system detects occurrence of an abnormal event, displaying a real-time image and/or sound of a camera apparatus located at the place, where the abnormal event occurs, in a virtual electronic map corresponding to the monitoring system, and/or replaying and displaying abstract information of a history monitoring video related to the place as needed.

Solution 20. The operation method according to Solution 18, wherein the performing an interactive operation for the object monitored by the monitoring system comprises: in the event of selecting a specific monitored object in a virtual electronic map corresponding to the monitoring system, generating and displaying on-line a history global route of the specific object among the N camera apparatuses, and/or replaying and displaying a history monitoring video of an area through which the specific monitored object passed as needed.

Solution 21. The operation method according to Solution 18, wherein the performing an interactive operation for the object monitored by the monitoring system comprises: when searching history monitoring information of the monitoring system for a specific monitored object, generating and displaying a history global route of the specific monitored object, and/or replaying history monitoring information captured by a camera apparatus comprised in an area through which the specific monitored object passed as needed.

Solution 22. The operation method according to Solution 18, wherein the monitoring system further comprises real-time monitoring and displaying apparatuses related to the N camera apparatuses, and icons corresponding to the N camera apparatuses are comprised in a virtual electronic map corresponding to the monitoring system, and the performing an interactive operation for the object monitored by the monitoring system comprises: when a specific icon in the virtual electronic map is selected, displaying in a real time way, by the real-time monitoring and displaying apparatus related to the camera apparatus corresponding to the specific icon, the image captured by the camera apparatus.

Although the invention has been disclosed above in the description of the embodiments of the invention, it shall be appreciated that the foregoing embodiments and examples are illustrative but not limiting. Those skilled in the art can devise various modifications, adaptations or equivalents to the invention without departing from the spirit and scope of the appended claims. These modifications, adaptations or equivalents shall also be construed as coming into the scope of the invention.

1. A monitoring device, comprising:
a similarity determining unit configured to, for an i^{th} camera apparatus among N camera apparatuses, perform feature conversion between a feature of an object in an image captured by the i^{th} camera apparatus and a feature of an object in an image captured by an j^{th} camera apparatus among the N camera apparatuses according to a pre-constructed feature conversion model between the camera apparatuses, and obtain respective first matching similarities of a specific object in the image captured by the i^{th} camera apparatus respectively with respect to one or more objects in the image captured by the j^{th} camera apparatus based on the result of feature conversion, wherein N is an integer greater than or equal to 2, i is an integer greater than or equal to 1 and less than or equal to N, j=1, 2, . . . , N, j is an integer, and i≠j; and
a monitoring unit configured to determine an object matching with the specific object in the image captured by the j^{th} camera apparatus based on the respective first matching similarities to thereby monitor the specific object.

2. The monitoring device according to claim 1, further comprising:
a temporal/spatial conversion probability distribution determining unit configured to obtain, for the i^{th} camera apparatus among the N camera apparatuses, respective temporal/spatial conversion probability distributions of the specific object in the image captured by the i^{th} camera apparatus and the one or more objects in the image captured by the j^{th} camera apparatus between the positions of the i^{th} camera apparatus and the j^{th} camera apparatus, respectively, according to a temporal/spatial conversion probability model between the camera apparatuses; and
the monitoring unit is configured to determine the object matching with the specific object in the image captured by the j^{th} camera apparatus based on the respective first matching similarities and the respective temporal/spatial conversion probability distributions.

3. The monitoring device according to claim 1, wherein the feature conversion model is a color conversion model, and the color conversion model between the ith camera apparatus and the j^{th} camera apparatus represents a correspondence relationship between a color value of the object in the image captured by the i^{th} camera apparatus and a color value of the object in the image captured by the i^{th} camera apparatus.

4. The monitoring device according to claim 3, wherein the similarity determining unit comprises:
a sub-image area selecting sub-unit configured to select a sub-image area Objⁱ corresponding to the specific object in the image captured by the i^{th} camera apparatus and a sub-image area Obj^{j} corresponding to the any one object in the image captured by the j^{th} camera apparatus;
a color value difference determining sub-unit configured to obtain the difference between the color values of the two sub-image areas according to the color conversion model between the i^{th} camera apparatus and the j^{th} camera apparatus; and
a first matching similarity obtaining sub-unit configured to obtain the first matching similarity between the specific object and the any one object according to the obtained difference between the color values.

5. The monitoring device according to claim 2, wherein the temporal/spatial conversion probability distribution determining unit is configured to obtain the temporal/spatial conversion probability model between the i^{th} camera apparatus and the j^{th} camera apparatus by:
constructing a temporal/spatial conversion probability model, in a normal distribution, of the specific object between the i^{th} camera apparatus and the j^{th} camera apparatus based on a typical traveling speed of an object of the same category as the specific object in a monitoring system comprising the N camera apparatuses and a positional relationship between the i^{th} camera apparatus and the j^{th} camera apparatus.

6. The monitoring device according to claim 5, wherein the temporal/spatial conversion probability model determining unit comprises:
a speed parameter determining sub-unit configured to obtain, based on typical traveling speeds of M objects of the same category as the specific object in the monitoring system, the average v̅ and the variance σ of the traveling speeds of the objects of the category as:
v̅=Σₛ₌₁^{M}v^{s}/M,σ=\sqrt{Σₛ₌₁^{M}}(v− v̅)²/M
wherein v^{s} represents the traveling speed of the s^{th} object of the category, and s=1, 2, . . . , M; and
a temporal/spatial conversion model determining sun-unit configured to construct the temporal/spatial conversion probability model P(t|CAMⁱ, CAM^{j}) between the i^{th} camera apparatus and the j^{th} camera apparatus according to the obtained average v̅ and the variance σ of the traveling speeds:
$$P ( t \vert {CAM}^{i} , {CAM}^{j} ) = \frac{{e}^{\frac{{( t - \frac{{Dist}^{i , j}}{\overline{v}} )}^{2}}{2 {σ}_{t}^{2}}}}{\sqrt{2 {πσ}_{t}}}$$
$$wherein {σ}_{t} = \frac{{Dist}^{i , j}}{σ}$$
wherein CAMⁱ, CAM^{j} represent the i^{th} camera apparatus and the j^{th} camera apparatus, t represents a period of time elapsing from the specific object leaving the i^{th} camera apparatus to entering the j^{th} camera apparatus, and Dist^{i,j} represents the distance between the i^{th} camera apparatus and the j^{th} camera apparatus.

7. The monitoring device according to claim 2, wherein the monitoring unit comprises:
a second matching similarity determining sub-unit configured to determine respective second matching similarities between the specific object in the image captured by the i^{th} camera apparatus and the respective objects in the image captured by the j^{th} camera apparatus based on the respective first matching similarities and the respective temporal/spatial conversion probability distributions; and
an object determining sub-unit configured to determine an object with the highest second matching similarity as a monitored object matching with the specific object.

8. The monitoring device according to claim 7, wherein the object determining sub-unit is configured to determine an object with the highest second matching similarity above a predetermined threshold as the monitored object matching with the specific object.

9. The monitoring device according to claim 7, wherein the object determining sub-unit is further configured to:
obtain appearing time of the monitored object appears in any K camera apparatuses among the N camera apparatuses and the positions of the K camera apparatuses according to the matching result to thereby generate a route of the monitored object among the K camera apparatuses, wherein K is an integer greater than or equal to 2 and less than or equal to N; and/or
estimate a future possible route of the determined monitored object according to the motion direction of the monitored object.

10. The monitoring device according to claim 7, wherein the second matching similarity determining sub-unit is configured to take a product of, a value obtained by addition after normalization of, or a weighted average value after normalization of the first matching similarity and the temporal/spatial conversion probability distribution related to any one object in the image captured by the j^{th} camera apparatus, as the second matching similarity corresponding to the any one object.

11. A monitoring method, comprising:
performing, for an i^{th} camera apparatus among N camera apparatuses, the operations of:
performing feature conversion between a feature of an object in an image captured by the i^{th} camera apparatus and a feature of an object in an image captured by an j^{th} camera apparatus among the N camera apparatuses according to a pre-constructed feature conversion model between the camera apparatuses, and obtaining respective first matching similarities of a specific object in the image captured by the i^{th} camera apparatus respectively with respect to one or more objects in the image captured by the j^{th} camera apparatus based on the result of feature conversion, wherein N is an integer greater than or equal to 2, i is an integer greater than or equal to 1 and less than or equal to N, j=1, 2, . . . , N, j is an integer, and i≠j; and
determining an object matching with the specific object in the image captured by the i^{th} camera apparatus based on the respective first matching similarities to thereby monitor the specific object.

12. A camera apparatus comprising a monitoring device, wherein the monitoring device comprises:
a similarity determining unit configured to, perform feature conversion between a feature of an object in an image captured by the camera apparatus and a feature of an object in an image captured by a second camera apparatus according to a pre-constructed feature conversion model between the camera apparatus and the second camera apparatus, and obtain respective first matching similarities of a specific object in the image captured by the second camera apparatus respectively with respect to one or more objects in the image captured by the camera apparatus based on the result of feature conversion; and
a monitoring unit configured to determine an object matching with the specific object in the image captured by the camera apparatus based on the respective first matching similarities to thereby monitor the specific object.

13. A monitoring system, comprising:
N camera apparatuses;
a monitoring device which comprises:
a similarity determining unit configured to, for an i^{th} camera apparatus among the N camera apparatuses, perform feature conversion between a feature of an object in an image captured by the i^{th} camera apparatus and a feature of an object in an image captured by a j^{th} camera apparatus among the N camera apparatuses according to a pre-constructed feature conversion model between the camera apparatuses, and obtain respective first matching similarities of a specific object in the image captured by the i^{th} camera apparatus respectively with respect to one or more objects in the image captured by the j^{th} camera apparatus based on the result of feature conversion, wherein N is an integer greater than or equal to 2, i is an integer greater than or equal to 1 and less than or equal to N, j=1, 2, . . . , N, j is an integer, and i≠j; and
a monitoring unit configured to determine an object matching with the specific object in the image captured by the j^{th} camera apparatus based on the respective first matching similarities to thereby monitor the specific object; and
an interface configured to receive an operation instruction and output monitoring information.

14. The monitoring system according to claim 13, wherein the interface is configured to, in response to an abnormal event detected by the monitoring system, display a real-time image and/or sound of a camera apparatus which captured the abnormal event, in a virtual electronic map corresponding to the monitoring system, and/or replay abstract information of a history monitoring video related to the abnormal event.

15. The monitoring system according to claim 13, wherein
the interface comprises a virtual electronic map corresponding to the monitoring system; and
the monitoring unit is configured to, in response to the operation instruction of selecting a specific monitored object in the virtual electronic map, generate a history global route of the specific object among the N camera apparatuses, and the interface is configured to display the history global route on the virtual electronic map and/or replay a history monitoring video of an area through which the specific monitored object passed.

16. The monitoring system according to claim 13, wherein
the interface comprises a virtual electronic map corresponding to the monitoring system; and
the monitoring unit is configured to, in response to the operation instruction of searching history monitoring information of the monitoring system for a specific monitored object, generate a history global route of the specific monitored object, and the interface is configured to display the history global route of the specific monitored object on the virtual electronic map and/or replay history monitoring information captured by a camera apparatus comprised in an area through which the specific monitored object passed.

17. The monitoring system according to claim 13, wherein the interface comprises real-time monitoring and displaying apparatuses related to the N camera apparatuses and a virtual electronic map corresponding to the monitoring system, wherein icons corresponding to the N camera apparatuses are comprised in the virtual electronic map, and the interface is configured to, in response to the operation instruction of selecting a specific icon in the virtual electronic map, make the real-time monitoring and displaying apparatus related to the camera apparatus corresponding to the specific icon display the image captured by the camera apparatus.

18. A program product comprising machine readable instruction codes stored therein, wherein the instruction codes, when read and executed by a machine, are capable of causing the machine to execute an object matching method, the method comprising:
performing feature conversion between a feature of a first object in a first image and a feature of one or more second objects in a second image according to a pre-constructed feature conversion model, and obtaining respective first matching similarities of the first object respectively with respect to the second objects in the second image based on the result of feature conversion; and
determining a second object matching with the first object based on the respective first matching similarities.

19. A machine readable storage medium with a program product carried thereon, wherein the program product comprises machine readable instruction codes stored therein, wherein the instruction codes, when read and executed by a machine, are capable of causing the machine to execute an object matching method, the method comprising:
performing feature conversion between a feature of a first object in a first image and a feature of one or more second objects in a second image according to a pre-constructed feature conversion model, and obtaining respective first matching similarities of the first object respectively with respect to the second objects in the second image based on the result of feature conversion; and
determining a second object matching with the first object based on the respective first matching similarities.
